(19) United States
(12) Patent Application Publication
(10) Pub. No.: US 2011/0232183 A1
(43) Pub. Date: Sep. 29, 2011

(54) WATER SUPPLY AND WETNESS ADJUSTMENT FLOWERPOT ASSEMBLY

(76) Inventor: Hsiao-An Chang, Taipei County (TW)

(21) Appl. No.: 12/748,456

(22) Filed: Mar. 29, 2010

(51) Int. Cl. A01G 9/02

(52) U.S. Cl. 47/65.9

(57) ABSTRACT

A water supply and wetness adjustment flowerpot assembly comprises a lower base having a plurality of supporting legs protruding from a lower side of a bottom of the lower base for supporting the lower base; an upper side of the lower base having a plurality of longitudinal and transversal trenches so as to form with a plurality of flowerpot bodies; each flowerpot body having an approximate rectangular shape; a plurality of flowerpot bodies can be arranged at one base in order for planting glasses or flowers; and a water absorption frame formed by a plurality of intersecting longitudinal and transversal strips which can be made individually or integrally; the water absorption frame being made of water absorption material; in assembly, the water absorption frame being placed in the notches of the flowerpot bodies for absorbing water.

### FIELD OF THE INVENTION

The present invention relates to flowerpots, and particularly to a water supply and wetness adjustment flowerpot assembly.

### BACKGROUND OF THE INVENTION

The prior art flowerpot has a bottle body for placing soil and water. A bottom of the bottler body has a hole for draining water. A disk can be placed below the bottle for accumulation of water and adjustment of water so that the flowerpot can retain a proper wetness.

However currently there is a usage for planting a plurality of glasses and flowers on a wall. Thus at this structure, a larger amount of flowerpots are necessary, while the prior art structure is not suitable for this object. Thus there is a newly design which accumulates a large amount of flowerpots together. However these designs are not good in water and wetness adjustment.

### SUMMARY OF THE INVENTION

Accordingly, the primary object of the present invention is to provide a water supply and wetness adjustment flowerpot assembly, which can accumulate a plurality of flowerpots together with the function of water supply adjustment and wetness adjustment.

To achieve above objects, the present invention provides a water supply and wetness adjustment flowerpot assembly, comprising: a lower base having a plurality of supporting legs protruding from a lower side of a bottom of the lower base for supporting the lower base 1; an upper side of the lower base having a plurality of longitudinal and transversal trenches so as to form with a plurality of flowerpot bodies; each flowerpot body having an approximate rectangular shape; a bottom of each flowerpot body formed with at least one water drain holes for draining water in the flowerpot body by above mentioned structure, a plurality of flowerpot bodies can be arranged at one base in order for planting glasses or flowers; a water absorption frame formed by a plurality of intersecting longitudinal and transversal strips which can be made individually or integrally; the water absorption frame being made of water absorption material; in assembly, the water absorption frame being placed in the notches of the flowerpot bodies for absorbing water.

Furthermore, the present invention provides another kind of water supply and wetness adjustment flowerpot assembly which comprises a lower base having a plurality of rectangular cell; each cell having at least one concave round corner; thus every four adjacent cell will form with a round hole; each round corner has a notch; a plurality of supporting legs 10 are extended from a lower side of a bottom of the lower base; and a water absorption frame formed by a plurality of intersecting longitudinal and transversal strips which can be made individually or integrally; the water absorption frame being made of water absorption material; in assembly, the water absorption frame being placed in the notches of the flowerpot bodies for absorbing water; thus the water absorption frame cab be inserted into notches of the lower base.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a schematic cross sectional view of the present invention.

FIG. 3 is a perspective view about the clamper of the present invention.

FIG. 4 is a schematic view showing the use of the clamper according to the present invention.

FIG. 5 is an elevational view of the structure illustrated in FIG. 4.

FIG. 6 is a schematic cross sectional view of the FIG. 4.

FIG. 7 is a schematic view showing an air tube is used in the structure of the present invention.

FIG. 8 is a schematic view about another embodiment of the present invention.

FIG. 9 is a cross sectional view of the structure illustrated in FIG. 8.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

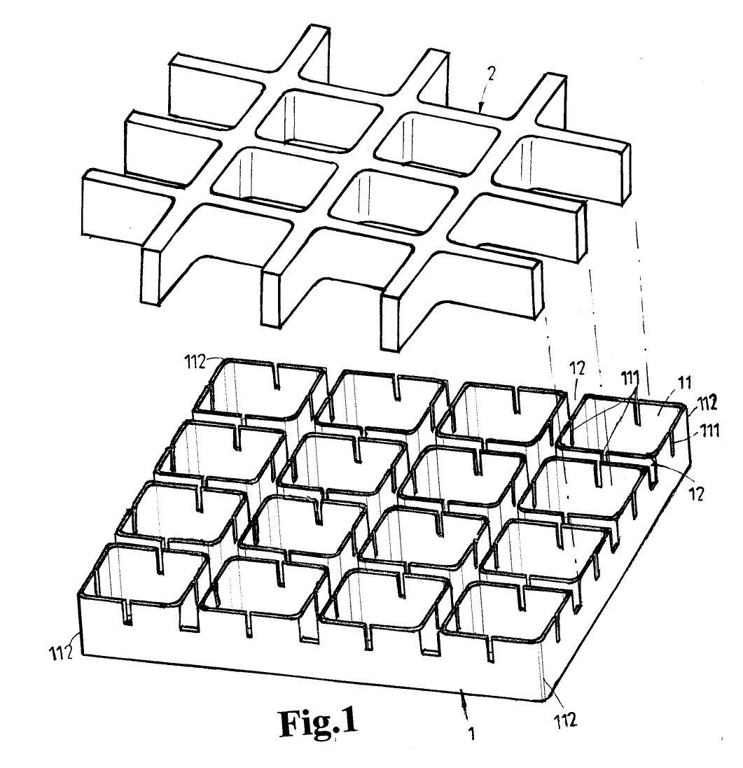

Referring to FIGS. 1 and 2, the structure of the present invention is illustrated. The present invention includes the following elements. A lower base 1 has a plurality of supporting legs 10 protruding from a lower side of a bottom of the lower base 1 for supporting the lower base 1. An upper side of the lower base 1 has a plurality of longitudinal and transversal trenches 12 so as to form with a plurality of flowerpot bodies 11. Each flowerpot body 11 has an approximate rectangular shape. Each corner of the flowerpot body 11 is a round corner so that the trenches 12 in every four adjacent flowerpot bodies 11 will form as a hollow hole 4 for air convention for achieving the function of wetness adjustment of each flowerpot bodies 11. In use, an air tube 5 can be inserted therein (as illustrated in FIG. 7) for preventing the obstruction of the hollow hole 5. A bottom of each flowerpot body 11 is formed with at least one water drain hole 110 for draining water in the flowerpot body 11. By above mentioned structure, a plurality of flowerpot bodies 11 can be arranged at one base in order for planting glasses or flowers. The structure of the lower base 1 of the present invention has a lower manufacturing cost and can be made easily. Each side of the flowerpot body 11 has a notch 111.

A water absorption frame 2 is formed by a plurality of intersecting longitudinal and transversal strips which can be made individually or integrally. The water absorption frame 2 is made of water absorption material. In assembly, the water absorption frame 2 is placed in the notches 111 of the flowerpot bodies 11 for absorbing water. In use, the water in the trenches 12 can be absorbed by the water absorption frame 2 and then the water is transferred into the flowerpot bodies 11 through the water absorption frame 2.

If too much water is accumulated in the flowerpot body 11, the surplus water can be drained out from the drain hole 110 at the bottom of the flowerpot body 11. Thus the wetness in the flowerpot body 11 is retained.

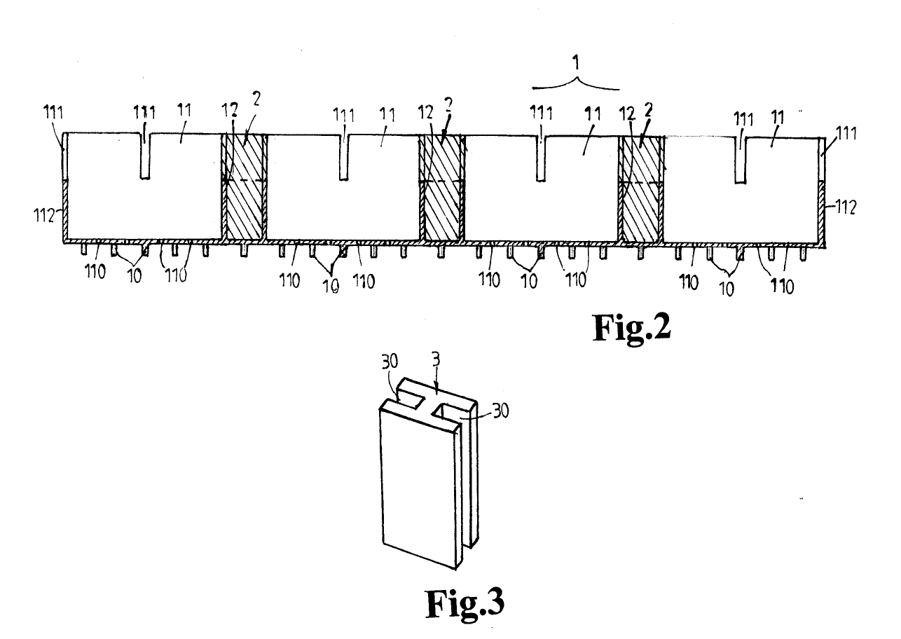

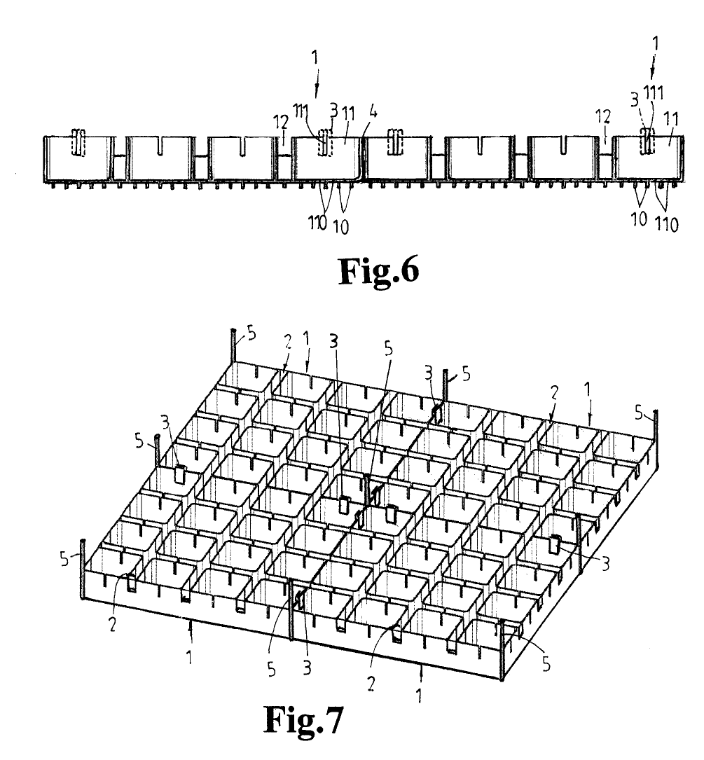

Referring to FIGS. 3 to 6, the clamper 3 of the present invention is illustrated. Generally, a plurality of amount of lower bases 1 is needed to be assembled for covering a whole wall. Thus there is a need for a novel clamper 3 which can combine units as one. The clamper 3 of the present invention is illustrated in FIG. 3. The clamper 3 has an H cross section with two grooves 30 at two sides.

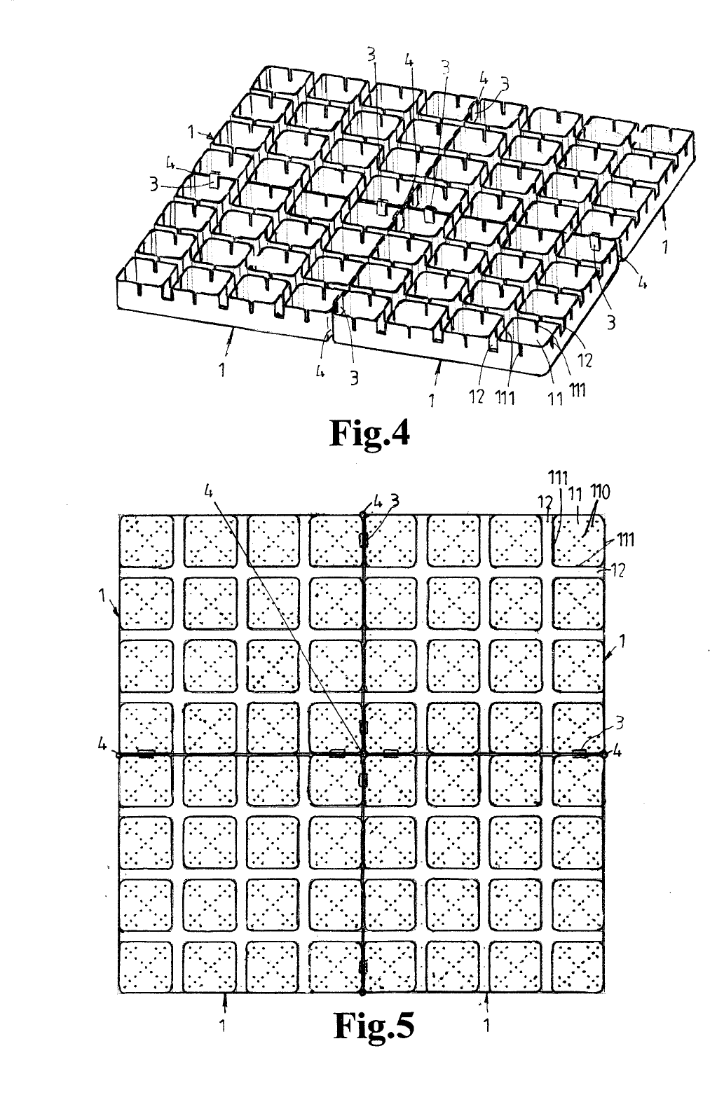

In use, referring to FIGS. 4 and 5, it is illustrated that one groove 30 of the clamper 3 will clamp two flowerpot bodies 11 belonging to two different flowerpot bodies 11 so as to combine two flowerpot bodies 11 as one unit.

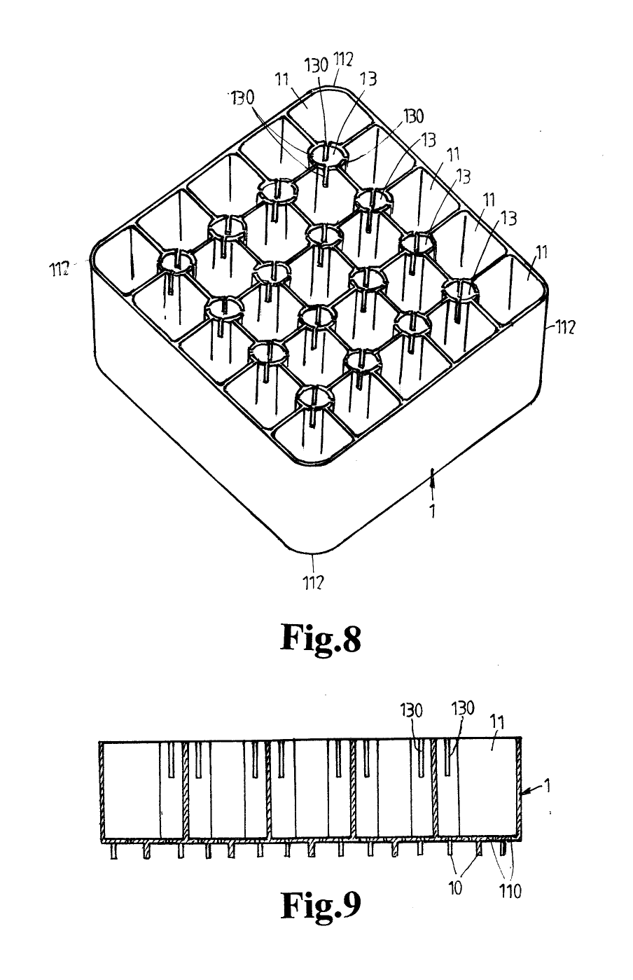

With referring to FIGS. 8 and 9, it is illustrated that the lower base 1 may have another kind of structure. The lower base 1 has a plurality of rectangular cell 11. Each cell 11 has at least one concave round corner. Thus every four adjacent cell 11 will form with a round hole 13. Each round corner has a notch 130. Thus the water absorption frame 2 illustrated in FIG. 1 can be inserted into notches 111 of the lower base 1. Furthermore, a plurality of supporting legs 10 are extended from a lower side of a bottom of the lower base 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A water supply and wetness adjustment flowerpot assembly, comprising:
a lower base having a plurality of supporting legs protruding from a lower side of a bottom of the lower base for supporting the lower base 1; an upper side of the lower base having a plurality of longitudinal and transversal trenches so as to form with a plurality of flowerpot bodies; each flowerpot body having an approximate rectangular shape; a bottom of each flowerpot body formed with at least one water drain holes for draining water in the flowerpot body by above mentioned structure, a plurality of flowerpot bodies can be arranged at one base in order for planting glasses or flowers; and
a water absorption frame formed by a plurality of intersecting longitudinal and transversal strips which can be made individually or integrally; the water absorption frame being made of water absorption material; in assembly, the water absorption frame being placed in the notches of the flowerpot bodies for absorbing water.

2. The water supply and wetness adjustment flowerpot assembly as claimed in claim 1, wherein each corner of the flowerpot body is a round corner so that the trenches in every four adjacent flowerpot bodies will form as a hollow hole for air convention so as to adjust the wetness of the each flowerpot bodies.

3. The water supply and wetness adjustment flowerpot assembly as claimed in claim 1, further comprising a clamper having an H cross section with two grooves at two sides for clamping two different flowerpot assembly.

4. A water supply and wetness adjustment flowerpot assembly, comprising:
a lower base having a plurality of rectangular cell; each cell having at least one concave round corner; thus every four adjacent cell will form with a round hole; each round corner has a notch; a plurality of supporting legs being extended from a lower side of a bottom of the lower base; and
a water absorption frame formed by a plurality of intersecting longitudinal and transversal strips which can be made individually or integrally; the water absorption frame being made of water absorption material; in assembly, the water absorption frame being placed in the notches of the flowerpot bodies for absorbing water.
